(19) United States
(12) Patent Application Publication
(10) Pub. No.: US 2004/0234918 A1
(43) Pub. Date: Nov. 25, 2004

(54) Combination of devices operational to increase the efficiency of storage tank or flow-through type waterheaters and hydronic boilers

(76) Inventor: William H. Velke, Campbellville (CA)

Correspondence Address: William H. Velke, 277 Campbellville Road, P.O. Box 154, Campbellville, ON, L0P 1B0, CA

(21) Appl. No.: 10/857,835

(22) Filed: Jun. 2, 2004

Related U.S. Application Data
(62) Division of application No. 10/443,052, filed on May 22, 2003.

(51) Int. Cl. F27B 3/20

(52) U.S. Cl. 432/94

(57) ABSTRACT

A combination of fluid treatment devices operating in unison for the purpose of significantly improving combustion efficiency and energy transfer rate of combustion equipment systems operating with fluid hydrocarbon fuels by significantly increasing the oxygen level in the combustion air/fuel mix from LLE (low level enhancement) to HLE (high level enhancement).

### FIELD OF THE INVENTION

This invention relates to water storage or flow-through type water heaters, and boilers for hydronic heating systems in domestic, commercial and industrial applications.

### BACKGROUND OF THE INVENTION

Typical water heaters or hydronic boilers in the present art consist of a water storage or water flow-through means, contained in an insulated casing defining a combustion chamber with a burner arrangement and a flue pass to exhaust combustion products.

The flue pass is usually placed through the center of the water storage or water flow-through conduit. Said water conduit is of a very limited surface configuration for the purpose of providing efficient heat transfer from the combustion and flue pass area to the water, and a significant amount of energy is thereby unused and wastefully exhausted. It is important to note that heat transfer efficiency is not only measured in terms of observed flue losses, but must also include the measured energy transfer duration per water volume.

In U.S. Pat. No. 4,825,813, a multi pipe once through boiler is disclosed, which includes a plurality of finned pipes connected to bottom and top headers. This disclosure is not suitable to function as a water storage heater, because the size of its annular combustion area in the center of the casing, and the configuration of pipes employed as water conduit area, limit the water storage volume and heat transfer water surface area.

Similar restrictions are disclosed in U.S. Pat. Nos. 4,909,191 and 5,365,887, wherein a flow-through water heater includes a number of vertical pipes connected to top and bottom headers with very limited water storage provision and insufficient water surface area for maximum rapid heat transfer.

The combination of maximum heat transfer efficiency together with maximum combustion efficiency provides the parameters for the most energy efficient burner appliance or combustion equipment design.

The usual burner configuration presently employed in combustion chamber areas, as well as the fuel supply manifolds leading to such burner configuration, do not provide adequate opportunity for the necessary pre-conditioning of a fluid hydrocarbon fuel prior to its ignition. Such pre-conditioning method assures improvement of fuel flow characteristics, chemical reactions and combustion kinetics during the fuel ignition and combustion process, allowing for maximum combustion efficiency.

In U.S. Pat. Nos. 5,888,060 and 6,290,487 B1, the inventor has already disclosed some of the benefits of pre-treating fuel prior to ignition. Such benefits included an increase in fuel flow velocity and fuel volume, resulting in the effects of fuel injection and a significant increase in combustion efficiency. But never before have the benefits of fuel pre-treatment, combustion air pre-treatment, and maximum energy transfer capability between operating fluids been combined in typical water heater or hydronic boiler equipment, to provide maximum total operating efficiency for such systems.

It must be further noted that the volume and condition of the combustion air, which is usually provided to the combustion chamber by way of a power venter or draft arrangement, is very critical. Many present art combustion equipment, especially hydronic boilers, are provided with mechanisms to control combustion airflow at a volume close to its stoiciometric ratio.

The condition of the combustion air may however also be controlled as to its molecular structure, and hence its oxygen ratio, which is a condition of major influence and effect on the intensity and efficiency of a fluid hydrocarbon fuel combustion process. In the past, combustion air was often conditioned through pre-heating, thereby increasing air volume and energy input into the combustion process. Such practice was accepted to be advantageous. However, it has now been found that the pre-heating of combustion air is more detrimental to the combustion process than any relative benefit derived from the increased energy input.

U.S. Pat. No. 6,374,911 discloses a combustion air cooler for automotive internal combustion engines for the purpose of increasing combustion air density, which in turn increases the oxygen ratio available at ignition. This practice provides measurable efficiency improvements.

No prior art disclosures were found which teach a method operational with the combination of devices employed for the purpose as contemplated by the Applicant.

### OBJECT OF THE INVENTION

It is an object of the present invention to provide an effective method and a combination of devices operational in accordance with such method, to significantly improve the performance and efficiency of combustion equipment like storage tank or flow through type water heaters and hydronic boilers. Such method is based on providing a novel combination of pre-treatment procedures consisting of:

1) altering the condition of fuel prior to ignition in order to improve combustion efficiency,

2) altering the condition of combustion air prior to it being mixed with said fuel in order to improve its oxygen ratio,

3) altering the condition and flow characteristics of the secondary fluid in order to improve the energy transfer rate between the primary fluids and the secondary energy transport fluid.

### SUMMARY OF THE INVENTION

The present invention therefore discloses a novel method to improve the volatility of fuel and of the chemical and kinetic reactants of the fuel and combustion air prior to mixing and ignition during the combustion process. It further discloses the alteration of the flow characteristics of the energy transport fluid in the equipment system. The method functions by operating a combination of devices in unison, all designed to improve fuel consumption, harmful emissions, ignition and combustion, and energy transfer efficiency in a combustion equipment system operating with fluid hydrocarbon fuels.

The combustion equipment system disclosed herein includes a casing, which may be insulated, defining a primary fluid conduit member which surrounds a secondary fluid conduit member in energy transfer relation. Said primary fluid conduit member further accommodates a burner arrangement located in a combustion chamber. Such primary fluid conduit member is therefore designed to transport primary fluids, like hydrocarbon fuel and combustion air, from a primary fluids inlet location to the combustion area for mixing and ignition at the burner arrangement, and from where subsequent combustion products are transported, preferably by power exhaust means, to a primary fluids exit location connected to an exhaust stack at the exterior of the casing. Said secondary fluid conduit member is designed to transport a fluid functioning as the energy distributor of the system and has an inlet port and an outlet port connected to the fluid transport system. Said conduit member is designed specifically to alter fluid flow dynamics and energy transfer efficiency between primary and secondary fluids at a rate and effectiveness exceeding prior art teachings.

The herein disclosed novel method is operational by employing the combination of three separate treatment devices in unison, wherein each device is of a specific design and performs a specific function to obtain a total system performance improvement as follows:

First Treatment Device:

Designed as first energy exchange means and installed at the combustion air intake location of the equipment casing, with the objective to maintain a temperature reduction of combustion air to a level from below ambient to 0 degrees F. prior to its mixing with fuel for ignition and combustion. The resulting change in molecular structure and kinetic makeup of the air increases the rate of oxygen available at combustion by up to 75% per volume of combustion air, and hence significantly improves combustion performance. Said first heat exchanger assembly derives the necessary cooling action either from low temperature incoming fuel entering the equipment, or from cooling means unrelated to the equipment.

Second Treatment Device:

Designed as second energy exchange means defining a secondary fluid conduit device operational to accommodate energy transfer between the primary and secondary fluids of the equipment system. The conduit device is designed such as to change the flow characteristics of the secondary fluid from laminar to turbulent. This is achieved by providing the interior surface of said conduit with strategically placed fluid flow interrupters, like dimples or ridges. Construction of such flow interrupters may in turn effect the exterior surface of such conduit to the extent that a more effective surface area is available for improved energy transfer efficiency between the primary fluids making contact with said exterior surface and the secondary fluid being transported within the conduit. Such secondary fluid conduit device is therefore preferably constructed from thin walled corrugated stainless steel tubing formed into a series of coils with a single fluid inlet and a single fluid outlet, without the need for headers and bypass connectors which are all common in prior art disclosures. The available active surface area in said second energy exchange means will effectively increase by a factor of 2 if the corrugation ridges or dimples are designed such as to double the surface area per length of tubing. Through placement of said corrugated tubing in the shape of a series of coils nested into each other, especially for application in flow-through type fluid heaters, the effective energy transfer surface area can be increased by between a factor of 2 to a factor of 4 over prior art disclosures.

Third Treatment Device:

Designed as third energy exchange means for the transport of fluid hydrocarbon fuel from a general fuel supply outside the casing to a heating zone inside the combustion area of the equipment system in heat transfer relation, for the purpose of creating a superior fuel combustibility condition prior to ignition. This condition is achieved by initially aggravating fuel flow during transport and changing its characteristics from laminar to turbulent by changing the conduit interior surface design, similar to the condition already disclosed for the second energy exchange means. In addition, fuel volatility and kinetic makeup is significantly improved through increasing fuel temperature from ambient to a level of between 500 degrees F. and the fuel's ignition temperature to achieve maximum combustion efficiency. During combustion tests, the operation of a device similar to said third fluid treatment device, functioning on its own and without the accumulative benefit of the other two additional devices herein disclosed, has already demonstrated combustion efficiency improvements and fuel consumption reductions of up to 17%.

The novel method of operating the three herein disclosed treatment devices in unison and operating conjunction, and in combination with each other as detailed, will achieve maximum improved combustion equipment performance with the variety of systems as herein described. The total equipment performance improvement obtainable with this operating method has not been taught in any prior art disclosure for similar components or equipment.

For a better understanding of the present invention and how the disclosed devices operate in accordance with the method herein disclosed, reference should be had to the drawings and descriptions in which there are detailed and illustrated the preferred embodiments of the invention.

However, while only a few embodiments of the invention have been illustrated and described, it is not intended to be limited thereby but only by the scope of the appended claims.

### BRIEF DESCRIPTION OF THE DRAWINGS

FIG. 1 of the drawings appended hereto depicts a general cut-away view of a combustion equipment system, in front elevation, including a primary conduit member surrounding a combustion chamber, a fuel manifold and burner arrangement, a secondary conduit member, and three individual treatment devices, all illustrating the general layout of components and method of operation of the invention.

FIG. 2 of the drawings appended hereto depicts a plan view of the secondary treatment device as shown in FIG. 1, defining a layout for a typical fluid storage tank equipment configuration and spacing rack located within the equipment casing.

FIG. 3 of the drawings appended hereto depicts a plan view of the secondary treatment device as shown in FIG. 1, defining a layout for a typical fluid flow-through equipment configuration and spacing rack located within the equipment casing.

FIG. 4 of the drawings appended hereto depicts a view of a portion of corrugated tubing that may be employed in the construction of each of the three treatment devices.

### DETAILED DESCRIPTION OF A PREFERRED EMBODIMENT

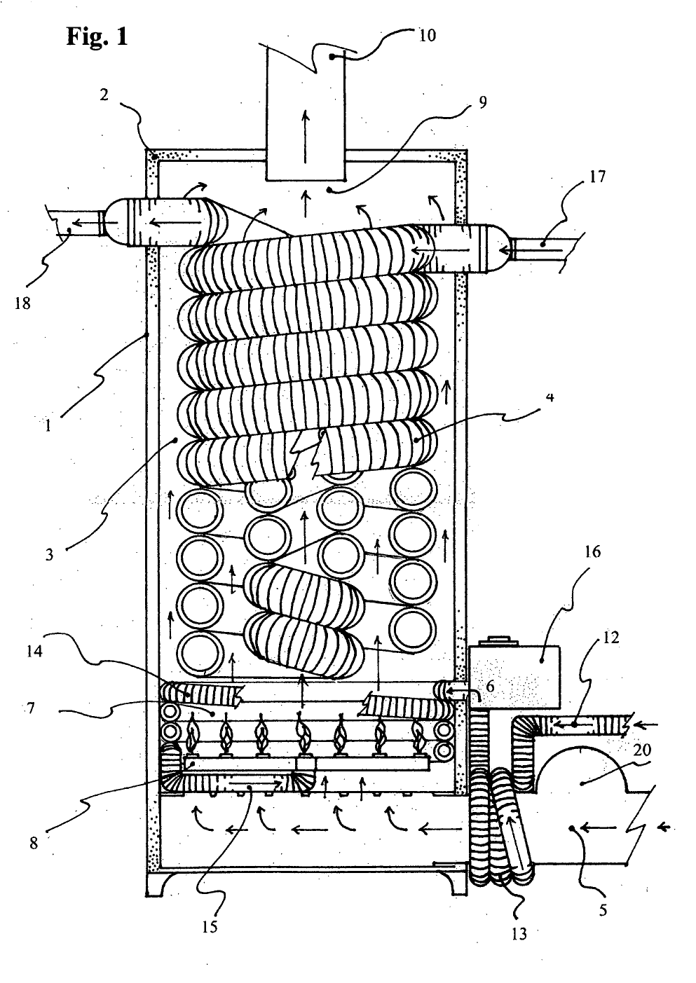

Referring now to FIG. 1 of the drawings there is shown in sectional view, front elevation, a combustion equipment system including a casing 1, which may be equipped with insulation material 2, defining a primary conduit device 3 designed to enclose a secondary conduit device 4. Said primary conduit device 3 is designed with intake means for the supply of combustion air 5 and fluid hydrocarbon fuel 6 from outside the casing for mixing and ignition in a combustion chamber 7 by way of a burner arrangement 8. The resulting combustion products 11 are routed via the primary conduit device 3 to an exhaust area 9 connected to exit stack 10 outside the casing. The primary conduit device 3, the flow capacity of which is calculated by deducting the space occupied by the secondary conduit device or second energy exchange means 4 from the interior space defined by the casing, must have a flow capacity of at least equal the volume and flow delivery capacity for combustion air 5, in accordance with the cfm air capacity of power fan 20 through air inlet 5, combined with the cfm capacity of the specified fuel flow through inlet 6.

The fuel for operating the combustion system is routed from its intake connection location 12 to the combustion chamber 7 via a first energy exchange means 13, constructed from thin walled stainless steel corrugated or dimpled tubing, for the purpose of assisting in reducing the combustion air temperature level significantly below ambient. Said first energy exchange means 13 may also include an additional known in the art air cooling mechanism.

The fuel is directed further through a third energy exchange means 14, via a typical fuel safety valve and regulator arrangement 16, for the purpose of elevating fuel temperature prior to mixing with combustion air and ignition in the orifice location at burner arrangement 8 via manifold 15. Such third energy exchange means 14 must again be constructed from thin walled, stainless steel corrugated or dimpled tubing, which provides the necessary mechanical means to change fuel flow dynamics from laminar to turbulent, and must be strategically located in combustion chamber 7. The change of fuel flow dynamics, in combination with raising fuel temperature to a substantial level, drastically alters the molecular structure and characteristics of the fuel to a more volatile and disassociated state, significantly effecting the process of fuel combining with the combustion air/oxygen mix. It will advance fuel ignition and generally improving overall equipment operating efficiency.

The secondary energy exchange means 4, with its fluid intake connection 17 and fluid exit connection 18, defines a conduit member constructed from thin walled, stainless steel corrugated or dimpled tubing, which provides the necessary mechanical means to change the flow characteristics of the fluid from laminar to turbulent. Such change in flow dynamics together with the effects obtained from the increase in conduit surface area provides a significant energy transfer improvement between the fluids in primary 3 and secondary 4 conduit devices.

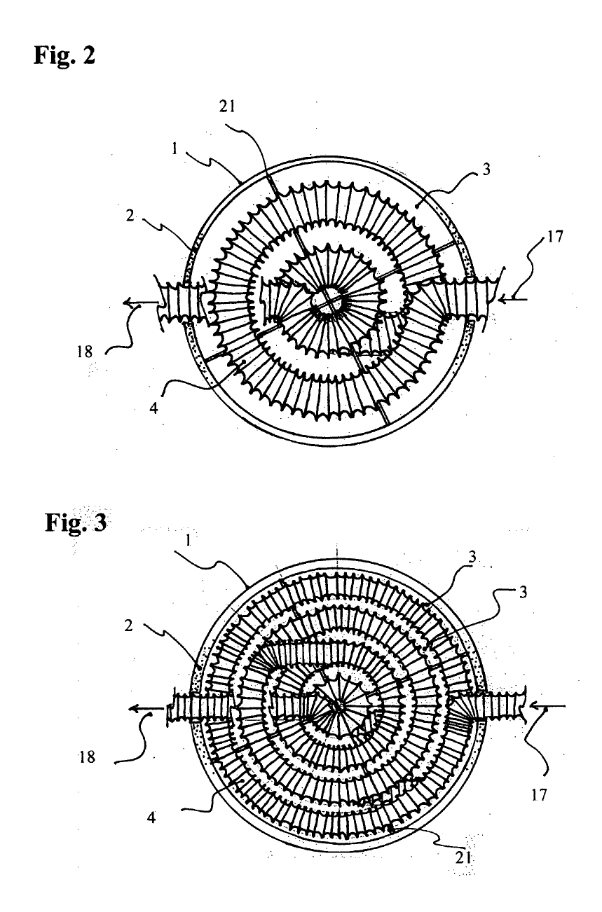

In FIG. 2 of the drawings there is shown in plan view, a layout of a secondary conduit device 4, located within the interior of primary conduit device 3, consisting of a continuous coil arrangement from corrugated or dimpled tubing with an inlet connection 17 and outlet connection 18, defining a preferred fluid storage tank type conduit configuration located in spacing rack 21. Said tubing configuration provides fluid storage means with a fluid surface contact area at a ratio of at least 2 to 1 per cfm of fluid over typical prior art tank storage means, when measuring energy transfer effectiveness between secondary and primary fluids. The dimensions of said coil arrangement, placed inside the primary conduit device, must always allow a total volume of primary fluids area 3 with a flow capacity of at least equal the volume and flow capacity for combustion air 5, in accordance with the cfm capacity of power fan 20 through air inlet 5, combined with the cfm capacity of the specified fuel flow through inlet 6.

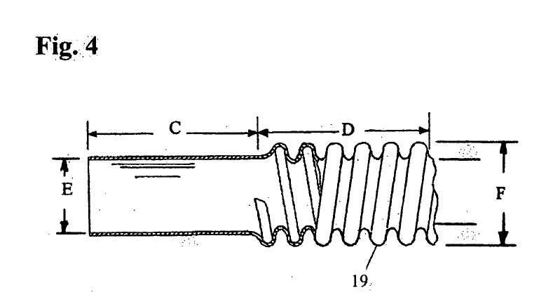

FIG. 3 of the drawings illustrates in plan view, a layout of a secondary conduit 4, consisting of a continuous coil arrangement from corrugated tubing, this time defining a preferred fluid flow-through type conduit configuration. Said configuration provides fluid flow-through means with a fluid surface contact area at a ratio of at least 4 to 1 per cfm of fluid over typical prior art flow-through means, when measuring energy transfer effectiveness between secondary and primary fluids. The dimensions of said coil arrangement, placed inside the primary conduit device, must again allow a total volume of primary fluids area 3 with a flow capacity of at least equal the volume and flow capacity for combustion air 5, in accordance with the cfm capacity of power fan 20 through air inlet 5, combined with the cfm capacity of the specified fuel flow through inlet 6.

In FIG. 4 of the drawings there is shown, in front elevation, a view of a typical portion of corrugated tubing 19, illustrating tube portion C and tube portion D, and wherein said tube portions are of equal length, but wherein the surface of portion D is equipped with corrugation channels which effectively change the interior flow dynamics from laminar to turbulent while increasing tubing surface area in accordance with the following calculations:

| | |
|---|---|
| Tubing portion C = F × 3.14 × C × 2 | 0.75″ × 3.14 × 12 × 2 = 56.52 sq″ |
| Tubing portion D = E × 3.14 × D | 0.50″ × 3.14 × 12 = 18.84 sq″ |

The difference in tubing surface area between portion C and D is therefore 37.68 sq″, representing an increase in effective surface area of 2 times.

The diameter E of the tube portion may govern the ratio of increase in effective energy transfer conduit member surface area of between 2 and 4.

I claim:

1. A combination of devices operating as fluid treatment devices in unison for the purpose of improving the energy transfer and combustion efficiency in combustion equipment systems operating with fluid hydrocarbon fuel like natural gas, propane gas, gasoline, diesel fuel, fuel oil, coal dust slurry or the like, having an ignition and combustion area, an energy conversion zone and a flue gas exhaust area, comprising:
a) a casing defining a primary conduit member directly surrounding a secondary conduit member in an energy transfer relation, wherein the primary conduit member is designed with intake means for the supply of primary fluids, like combustion air and fuel, from outside the casing to a combustion chamber and burner arrangement inside the casing, and, after ignition and combustion of the fuel and air mixture, transport combustion products and exhaust gases from the combustion area to an exhaust stack at the exit of the casing, and wherein said primary conduit member is designed for the efficient transfer of energy to the second conduit member, which is equipped with means to convert such energy to a secondary operating fluid, like water, oil, air or other similar fluid, for the purpose of transport and distribution throughout the system;
b) a primary conduit member equipped at its intake location with a combustion air conduit defining a first treatment device, including a blower arrangement, designed as first energy exchange means to control the constant temperature level, volume and velocity of combustion air flow for the combustion process;
c) a primary conduit member equipped at its intake location with a fuel conduit defining a third treatment device connected to a fuel manifold in an energy conversion zone of the combustion area, designed as third energy exchange means to control the constant temperature level and volatility of fluid hydrocarbon fuel supplied for ignition to a burner assembly strategically placed in the combustion area of the equipment;
d) a fuel inlet conduit connected at its outlet side to the fuel supply manifold member, and at the inlet side to fuel supply means which may include a required fuel safety valve and regulator arrangement;
e) a secondary conduit member defining a second treatment device functioning as second energy exchange means constructed from a continuous length of thin walled and light weight corrugated or dimpled stainless steel tubing of suitable diameter, formed into a series of coils without the need for headers, having a single inlet and a single outlet connection, and wherein the surface of said corrugated or dimpled tubing alters the fluid dynamics of any contacting fluid from laminar to turbulent, thereby improving energy transfer efficiency;

2. A primary conduit member according to claim 1, wherein the intake location is equipped with a first treatment device defined as a first energy exchange means to effectively control and decrease the constant temperature of the incoming combustion air supply to a level between substantially below typical ambient and minus 40 degrees F.;

3. A secondary conduit member according to claim 1, defining a second treatment device equipped with a second energy exchange means, wherein said corrugated or dimpled tubing provides fluid storage tank function with a fluid surface contact area at a ratio of at least 2 to 1 per cubic foot of fluid over typical prior art tank storage means, when measuring energy transfer effectiveness between secondary and primary fluids;

4. A secondary conduit member according to claim 1, defining a second treatment device equipped with a second energy exchange means, wherein said corrugated or dimpled tubing provides fluid flow-through function with a fluid surface contact area at a ratio of at least 4 to 1 per cubic foot of fluid over prior art flow-through tube-and-header means, when measuring energy transfer effectiveness between secondary and primary fluids;

5. A fuel supply conduit according to claim 1, which is constructed from thin-walled and light weight corrugated or dimpled stainless steel tubing for the purpose of altering flow dynamics and of suitable diameter to accommodate the required fuel volume flow, defining a third energy exchange means extending through a heating zone related to the combustion chamber and burner arrangement such as to heat fuel prior to ignition to a constant temperature of between 100 degrees F. and 900 degrees F., without exceeding the auto-ignition or vaporization temperature of the fuel, thereby altering the molecular structure of the fuel to a more volatile and disassociated state;

6. A combustion equipment system according to claim 1, which is designed to operate as a storage tank fluid heater.

7. A combustion equipment system according to claim 1, which is designed to operate as a flow-through fluid heater;

8. A combustion equipment system according to claim 1, which is designed to operate as a hydronic boiler;

9. A combustion equipment system according to claim 1, which is designed to operate as a warm air heater;

10. A combustion equipment system according to claim 1, which is designed to operate as a thermal or steam generator;

11. A combustion equipment system according to claim 1, which is designed to operate with at least one of the three disclosed treatment devices;

12. A combustion equipment system according to claim 1, which is designed to operate with at least two of the three disclosed treatment devices;

13. A combustion equipment system according to claim 1, wherein the secondary conduit member is equipped with energy exchange means to convert energy into a rotational force;
